(19) United States
(12) Patent Application Publication
(10) Pub. No.: US 2014/0169217 A1
(43) Pub. Date: Jun. 19, 2014

(54) SYSTEM AND METHOD FOR DISPLAYING NETWORK DATA

(71) Applicant: Trenton Gary Coroy, Steinbach (CA)

(72) Inventors: Trenton Gary Coroy, Steinbach (CA); Timothy Roy Koop, Ste. Anne (CA)

(73) Assignee: Trenton Gary Coroy, Steinbach (CA)

(21) Appl. No.: 14/104,403

(22) Filed: Dec. 12, 2013

Related U.S. Application Data
(60) Provisional application No. 61/737,306, filed on Dec. 14, 2012.

(51) Int. Cl. H04L 12/26; H04L 12/24

(52) U.S. Cl. CPC H04L 43/045; H04L 41/0853
USPC 370/254

(57) ABSTRACT

Described herein is a system and computer implemented method for displaying network data having a plurality of linked nodes. The method determines a set of linked nodes from downstream branches that emanate from a reference node and/or a parent reference node, and displays at least one of the linked nodes from the set of linked nodes to the user. The system may incorporate a processor, a memory, and a display for carrying out the method.

### RELATED APPLICATIONS

This application claims priority to U.S. Provisional Application No. 61/737,306, filed on Dec. 14, 2012 and entitled “SYSTEM AND METHOD FOR DISPLAYING NETWORK DATA”.

### TECHNICAL FIELD

The present disclosure is directed towards a computer implemented system and method for processing network data, and in particular, a system and method for processing and displaying network data having a tree structure.

### BACKGROUND

Network data may be used to record, model and characterize different types of phenomena, processes, or relationships. Network data may comprise nodes, each of which can represent a data structure, an individual, or an entity. The relationship between a pair of nodes may be determined according to the manner in which the nodes are linked. For example, nodes may be linked together by a parent-child or sender-recipient relationship. In general, the nodes of a network may comprise one or more various structures such as trees, lines, rings, stars or meshes.

### SUMMARY

According to an aspect, a computer-implemented method for displaying network data having a plurality of linked nodes is disclosed. The method comprising: (a) determining which of the linked nodes is a reference node based on a first user input; (b) determining whether the reference node has at least one parent node, and if the reference node has at least one parent node (i) determining a parent reference node; and (ii) determining a set of linked nodes from downstream branches that emanate from the parent reference node; otherwise (iii) determining a set of linked nodes from downstream branches that emanate from the reference node; and (c) displaying at least one of the linked nodes from the set of linked nodes to the user.

According to another aspect, a system for displaying network data having a plurality of nodes is disclosed. The system comprising: (a) a processor; (b) a display communicatively linked to the processor; and (c) a memory communicatively linked to the processor, the memory having encoded thereon statements and instructions to configure the system to carry out a method for displaying network data having a plurality of linked nodes. The method comprising: (d) determining which of the linked nodes is a reference node based on a first user input; (e) determining whether the reference node has at least one parent node, and if the reference node has at least one parent node (i) determining a parent reference node; and (ii) determining a set of linked nodes from downstream branches that emanate from the parent reference node; otherwise (iii) determining a set of linked nodes from downstream branches that emanate from the reference node; and (f) displaying at least one of the linked nodes from the set of linked nodes to the user.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more exemplary embodiments:

FIG. 1 is a set of network data, according to an embodiment where nodes have no more than a single parent node.

FIGS. 2 to 8 show a display area displaying portions of the network data of FIG. 1, according to different embodiments.

FIG. 9 is a block diagram of a system for displaying network data, according to another embodiment.

FIG. 10 is a block diagram of a network for displaying network data, according to another embodiment.

FIG. 11 is another set of network data, according to an embodiment where nodes may have multiple parent nodes.

FIGS. 12 to 19 show a display area displaying portions of the network data of FIG. 11, according to different embodiments.

FIG. 20 is another set of network data, according to an embodiment where nodes have no more than a single parent node.

FIG. 21(a) is a set of network data representing the distribution of a chain message between users of a social network.

FIGS. 21(b)-(c) show a display area displaying portions of the network data of FIG. 21(a), according to different embodiments.

### DETAILED DESCRIPTION

Determining the relationships between nodes representing network data becomes increasingly difficult as the number of nodes increases. An expanded view displaying large portions of network data may be required to visualize the relationship between two nodes that are far apart. However, it may be impossible to suitably display large portions of network data on small browser windows when the network represents a large data set. This problem is exacerbated by the emergence and use of mobile technologies, such as smart-phones, PDA's, notebooks, and tablet computers, which typically use displays significantly smaller than conventional personal computers. Moreover, a user may only wish to see nodes that are sufficiently related to a particular reference node, and a full or partially zoomed display of the network data unnecessarily includes other nodes that the user is not interested in. Accordingly, a method for processing and displaying network data in a simplified, informative, and relevant manner, while also using display area efficiently, is needed.

Embodiments of the present disclosure are directed towards a system and method for processing, organizing, and displaying network data, and in particular, processing and displaying network data while efficiently using display area. The network data may comprise a tree structure, such as family tree data, genealogy data, transmission history data, corporate structure data, multi-level marketing data, and social relationship data. Using the disclosed system and method, a user may obtain relational information for an indicated reference node, including an indication of whether other nodes are proximate to or sufficiently related to the reference node. By determining which nodes are proximate to or sufficiently related to the reference node, other comparatively irrelevant nodes may be hidden, thereby allowing the display area to be used efficiently. This provides the user with a simplified, informative, and relevant display of sufficiently related nodes for a given reference node.

### Node Relation Terminology

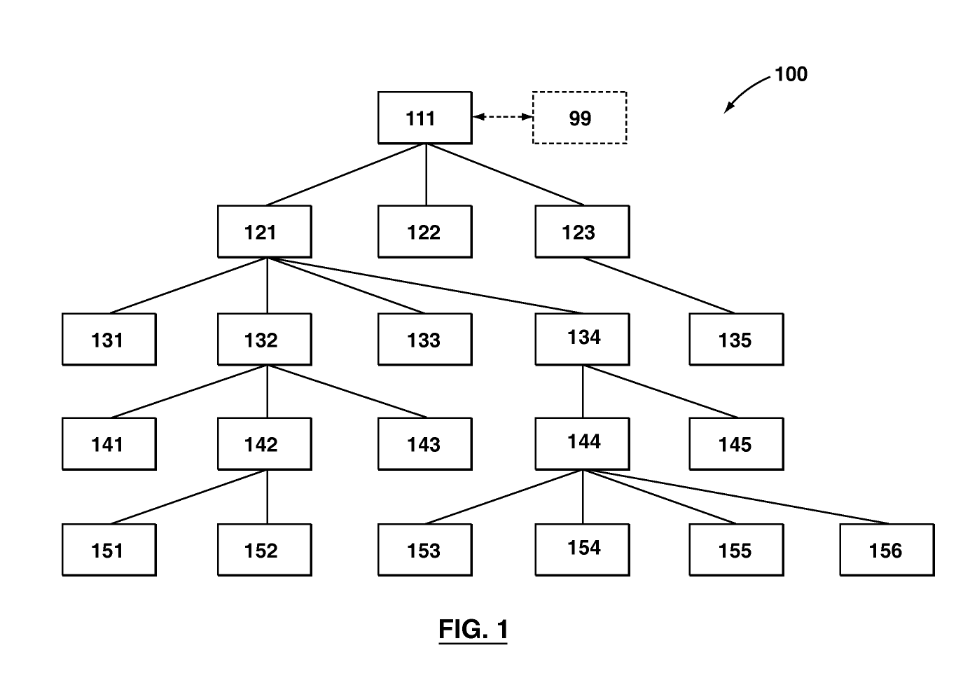

FIG. 1 shows an exemplary set of network data 100 according to an embodiment. The network data 100 comprises a plurality of nodes 111-156 that are linked together to form a tree structure. In this example, node 111 is the “root node” being at the top of the tree structure. Pairs of nodes that are directly and vertically linked in the network data 100 have a parent-child relationship, with the node closer to the root node (e.g. the node that is positioned as the higher of the two nodes in FIG. 1) referred to as the “parent” node, and the other node referred to as the “child” node. For example, node 121 is directly and vertically linked to nodes 131-134. Accordingly, node 121 is the “parent” of nodes 131-134, and nodes 131-134 are the “child” nodes of node 121. Nodes that share the same “parent node” have a sibling relationship; such nodes do not necessarily need to be directly linked together. For example, nodes 121-123 are siblings of each other as they share the same parent node (node 111). Pairs of nodes that are vertically linked together through a single intervening node have a grandparent-grandchild relationship. For example, node 111 is the “grandparent” of node 135 through intervening node 123, and node 135 is the “grandchild” of node 111. As used in this disclosure, the terms “parent”, “sibling”, “child”, “grandparent”, and “grandchild” are relative terms that may describe a relationship between a pair of nodes, and are not limiting references to a particular node or set of nodes. Nodes that do not have a “parent” node are referred to as “root nodes” (such as node 111 as described above). Nodes that do not have any “children” are referred to as “terminal nodes”, such as nodes 122, 131, 133, 135, 141, 143, 145, and 151-156 in FIG. 1. Nodes that are linked to “parent” and “child” nodes are referred to as “intervening nodes”. In this way, each of nodes 111-156 may be classified as a “root”, “terminal” or “intervening” node, and are arranged to form a tree structure through multiple parent-child relationships between various pairs of nodes.

In embodiments where nodes may have multiple parents, sibling nodes may comprise primary sibling nodes and secondary sibling nodes. A primary sibling node is a sibling node to a reference node which emanates from a parent reference node. A secondary sibling node is a sibling node to a reference node which does not emanate from a parent reference node (i.e. the secondary sibling node emanates from a parent node which is not the parent reference node). This and other related concepts will be explained in further detail below.

### Determining Upstream and Downstream Branches

The disclosed system and method determine various upstream and downstream branches of network data 100 from a reference node, and/or a parent node of the reference node (“parent reference node”). Determining upstream and downstream branches from a reference node or a parent reference node may identify nodes proximate to, or sufficiently related to the reference node; these may include nodes having the same lineage as the reference node and other nodes which may be of particular importance to the user. In other embodiments however, the system and method may also determine upstream and downstream branches from any related node to the reference node (such as a child or grandparent node of the reference node).

Each downstream branch comprises a particular node (for example, a reference node or a parent reference node), one end node, and a set of nodes linked between the particular node and the one end node. Each upstream branch comprises a particular node, one end node, and a set of nodes linked between the particular node and the one end node. The end node may comprise a node linked to the particular node through a certain number of intervening nodes (for example, the end node may be a node which is separated from the particular node by two intervening nodes). In the depicted embodiments however, each downstream branch comprises a particular node, one terminal node, and a set of nodes linked between the particular node and the one terminal node. Each upstream branch comprises a particular node, one root node, and a set of nodes linked between the particular node and the one root node.

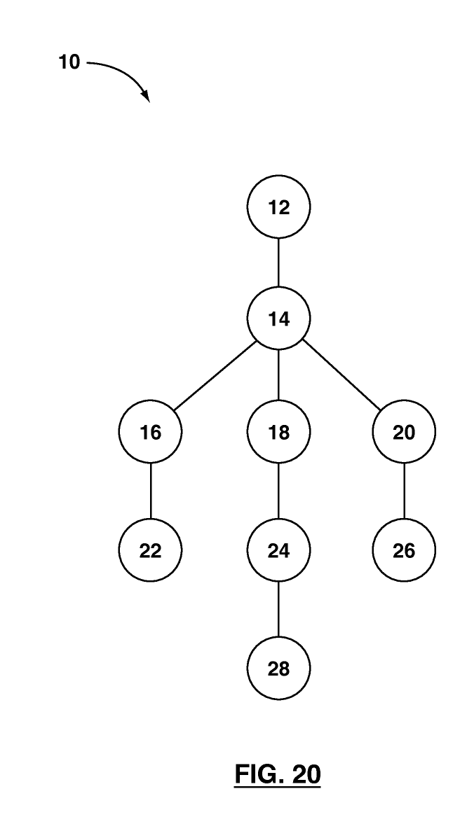

For example, using the exemplary set of network data 10 in FIG. 20, a tree structure is shown comprising a reference node 18, a parent node 14, a grandparent node 12, sibling nodes 16 and 20, child node 24, grandchild node 28, and niece/nephew nodes 22 and 26. A downstream branch from the reference node 18 comprises child node 24, and grandchild node 28. One downstream branch from parent node 14 comprises parent node 14, sibling node 16, and niece/nephew node 22. Another downstream branch from parent node 14 comprises parent node 14, reference node 18, child node 24, and grandchild node 28. Yet another downstream branch from parent node 14 comprises parent node 14, sibling node 20, and niece/nephew node 26. An upstream branch from reference node 18 comprises reference node 18, parent node 14, and grandparent node 12. Accordingly, determining upstream and downstream branches may identify a set of linked nodes comprising “grandparent”, “parent”, “sibling”, “child”, “grandchild”, and “niece/nephew” nodes of the reference node. Nodes that are of particular interest to a user, whether by relational proximity, lineage, or specific relationship, may be determined from these branches and displayed to the user.

To further illustrate this example using FIG. 1, a set of linked nodes can be determined through downstream branches from the reference node, which may include child, grandchild, and more distantly related nodes sharing a direct lineage with the reference node. According to an embodiment where node 111 is selected as the reference node, each of its downstream branches comprise node 111, one of terminal nodes 122, 131, 133, 135, 141, 143, 145, and 151-156, and the intermediate nodes (if any) linking node 111 to one of the terminal nodes in a downstream manner. For example, a first downstream branch comprises nodes 111, 121, and 131, a second downstream branch comprises nodes 111 and 122, a third downstream branch comprises nodes 111, 123, and 135, and so forth. Table 1 below lists downstream branches, and a set of linked nodes determined from each of the downstream branches which emanate from node 111 in the network data 100 of FIG. 1.

TABLE 1
List of downstream branches from node 111 in FIG. 1

| Branch No. | Nodes |
|---|---|
| 1 | 111, 121, 131 |
| 2 | 111, 122 |
| 3 | 111, 123, 135 |
| 4 | 111, 121, 133 |
| 5 | 111, 121, 132, 141 |
| 6 | 111, 121, 132, 143 |
| 7 | 111, 121, 132, 142, 151 |
| 8 | 111, 121, 132, 142, 152 |
| 9 | 111, 121, 134, 145 |
| 10 | 111, 121, 134, 144, 153 |
| 11 | 111, 121, 134, 144, 154 |
| 12 | 111, 121, 134, 144, 155 |
| 13 | 111, 121, 134, 144, 156 |

The child nodes of the reference node (node 111 in this example) may be identified from the set of linked nodes in Table 1 as the nodes in a downstream branch which have a single degree of separation from node 111 (i.e. nodes that are directly linked to node 111, such as nodes 121-123), grandchild nodes may be identified as having two degrees of separation from node 111 (i.e. linked through a single intervening node, such as nodes 131-135), and so forth. In this way, child, grandchild, or other nodes having a shared linage with the reference node, may be determined for display to a user.

Sibling, niece/nephew, and other nodes having a diverged lineage from the reference node can be identified by determining a set of linked nodes from downstream branches emanating from a parent reference node. The parent reference node is a node that may be selected from one or more parent nodes of the reference node. The parent reference node can be directly selected by the user through a user input, or may be determined by the system based on the availability of parent nodes, or previous settings of the parent reference node. For example, in embodiments where a reference node has a single parent node, the single parent node serves as the parent reference node. When the reference node has a plurality of parent nodes, the parent reference node may be selected as a parent node which was also a previously selected parent reference node, or may be selected as a parent node which was also a previously selected reference node, or may be selected as a parent node which is also a parent node of a previously selected reference node.

For example, if node 142 in FIG. 1 is selected as a reference node, node 132 is the parent reference node since it is also the only parent node. Downstream branches from the parent reference node (node 132) may be determined as shown in Table 2 below

TABLE 2
List of downstream branches from node 132 in FIG. 1

| Branch No. | Nodes |
|---|---|
| 1 | 132, 141 |
| 2 | 132, 142, 151 |
| 3 | 132, 142, 152 |
| 4 | 132, 143 |

From the set of nodes in Table 2 above, sibling nodes of reference node 142 are identified as the nodes other than reference node 142 having a single degree of separation from parent reference node 132 (nodes 141 and 143). In other embodiments (not shown), niece/nephew nodes may be identified as nodes having two degrees of separation from parent reference node 132 in branches which exclude the reference node.

Moreover, child, grandchild, and other nodes sharing a lineage with a reference node may also be determined through downstream branches of the parent reference node; these downstream branches would therefore comprise the reference node as a node in the branch. Using Table 2 above for example, the second and third downstream branches from parent reference node 132 contain child nodes 151, 152 of reference node 142. In this way, if the selected reference node has a parent node, downstream branches from parent reference node may be used to identify the reference node's children and grandchildren in addition to its siblings from the same parent reference node. In other embodiments (not shown), downstream branches of the reference node's grandparent may be determined to identify “cousin” nodes to the reference node.

Parent, grandparent, and other ancestor nodes may be determined from a second set of linked nodes comprising nodes of upstream branches from the reference node. For example, if node 142 in FIG. 1 is selected as a reference node, the second set of linked nodes comprises the nodes in the only upstream branch which are nodes 142, 132, 121, and 111 in this embodiment. Parent nodes may be identified as having a single degree of separation upstream from reference node 142 (node 132), grandparent nodes may be identified as having two degrees of separation upstream from node 142 (node 121), and so forth.

Accordingly, by determining downstream and/or upstream branches from the reference node and parent reference node, sets of linked nodes may determined, and nodes having certain relationships to the reference node may be determined from the set of linked nodes for display to the user. These may include the reference node's sibling, parent, grandparent, child, and grandchild nodes. In other embodiments however, any node related to the reference node may be used for determining downstream and/or upstream branches (for example, a grandparent node), according to the desired level of relational proximity to the reference node.

In certain embodiments, the disclosed system and method may exclude certain nodes from being displayed. This provides for efficient use of display area, and may reduce screen size requirements. For example, a user may only be interested in viewing a reference node's parents, siblings, and children. Other more distant nodes, such as “uncle/aunt” or “cousin” nodes, are comparatively irrelevant to the user.

According to one embodiment where nodes may have multiple parent nodes, the display of sibling nodes may include those which emanate from the parent reference node. This method further comprises determining primary sibling nodes as sibling nodes of the reference node which emanate from the parent reference node, and displaying at least one of the primary sibling nodes to the user.

In another embodiment where nodes may also have multiple parent nodes, sibling nodes not directly related to the parent reference node can be excluded from display to the user to minimize display area. This method further comprises determining secondary sibling nodes as sibling nodes of the reference node which do not emanate from the parent reference node, and excluding at least one of the secondary sibling nodes from being displayed to the user.

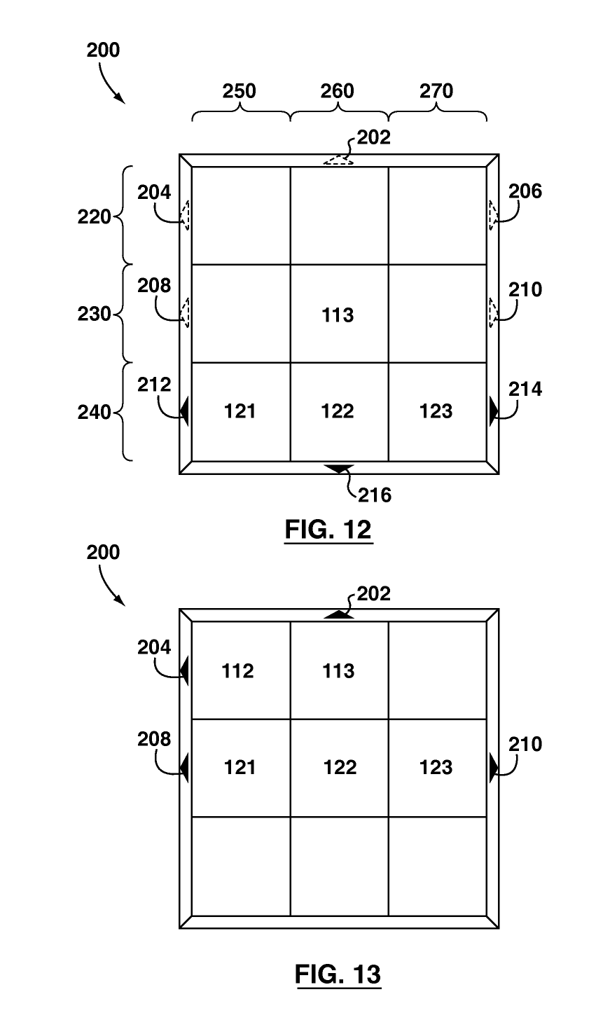

Accordingly, in embodiments involving nodes having multiple parent nodes, the disclosed system and method distinguishes primary sibling nodes from secondary sibling nodes, and may only display the primary sibling nodes to the user, while excluding display of the secondary sibling nodes. This is shown for example, in FIGS. 12-19 below.

In embodiments where more distant nodes, such as “uncle”, “cousin”, “second cousin”, “secondary sibling” etc. are to be excluded from display to the user, the system and method may further operate as follows. When the reference node has at least one grandparent node, a reference grandparent node will be determined from the at least one grandparent node. At least a primary branch will be determined as a downstream branch which emanates from the reference grandparent node and also includes the reference node. A third set of linked nodes will be determined from downstream branches emanating from the reference grandparent node, but which exclude the nodes of the primary branch. In this way, the third set of linked nodes may comprise more distant nodes such as “uncle”, “cousin”, “second cousin”, “secondary sibling” etc., but may exclude more proximate nodes such as “reference grandparent”, “reference parent”, “primary sibling”, “children”, and “grandchildren”. Finally, at least one of the linked nodes from the third set of linked nodes may be excluded from display to the user.

An illustrative example using the exemplary set of network data 100 in FIG. 1 will now be disclosed, in which a reference node's “uncles”, “cousins” or more distant nodes are to be excluded from display to the user. If a user selects node 132 as the reference node, node 121 becomes the parent reference node as the only parent node, and node 111 becomes the reference grandparent node as the only grandparent node. Downstream branches from grandparent node 111 may be determined and are shown below in Table 3.

TABLE 3
List of downstream branches from grandparent node 111 in FIG. 1

| Branch No. | Nodes |
|---|---|
| 1 | 111, 121, 131 |
| 2 | 111, 122 |
| 3 | 111, 123, 135 |
| 4 | 111, 121, 133 |
| 5 | 111, 121, 132, 141 |
| 6 | 111, 121, 132, 143 |
| 7 | 111, 121, 132, 142, 151 |
| 8 | 111, 121, 132, 142, 152 |
| 9 | 111, 121, 134, 145 |
| 10 | 111, 121, 134, 144, 153 |
| 11 | 111, 121, 134, 144, 154 |
| 12 | 111, 121, 134, 144, 155 |
| 13 | 111, 121, 134, 144, 156 |

From Table 3, primary branches may be determined as the branches which include the reference node. In this embodiment, node 132 is the reference node, and the primary branches comprise Branch Nos. 5, 6, 7, and 8. A third set of linked nodes may be determined from the nodes in Table 3 which excludes the nodes of the primary branches. Accordingly, the third set of linked nodes will comprise reference node 132's more distant nodes such as “cousin” nodes (node 135) and “aunt/uncle” nodes (nodes 122, 123) which can then be excluded from display to the user. The primary branches may comprise more directly related nodes such as child (nodes 141-143), grandchild (nodes 151-152), parent (node 121), and grandparent (node 111) nodes, which may instead displayed to the user.

### Display of Single-Parent Network Data

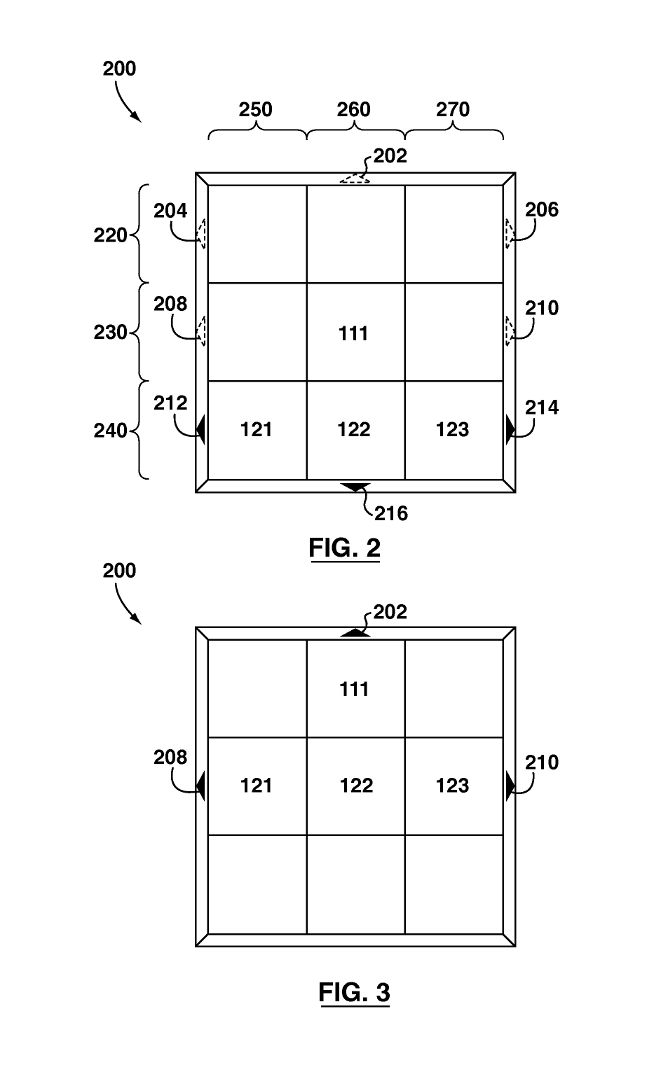

FIGS. 2-8 are graphical user interfaces 200 that may be used to display network data to a user, according to various embodiments of the present disclosure. The nodes displayed in the user interfaces 200 of FIGS. 2-8 are determined according to a user selected reference node from the “single-parent” network data 100 in FIG. 1, which comprises nodes having no more than one parent node. In other embodiments however, as will be described below, the disclosed system and method is capable of determining and displaying nodes from network data comprising multiple-parent nodes (i.e. nodes that have two or more parent nodes).

User interface 200 in FIGS. 2-8 comprise a matrix of nine cells arranged in a 3×3 array that is formed from intersecting three rows (upper row 220, central row 230, lower row 240) and three columns (left column 250, central column 260, right column 270). As used in this disclosure, the term “central” is relative to the composition of the matrix, and may comprise a center location for some matrices, or a location near the center of other matrices. Each cell of the interface 200 may be used to display a node 111-156 from network data 100 in FIG. 1. A reference node is displayed in the center of the user interface 200 (at central row 230 and central column 260). Siblings of the reference node are shown in the central row 230 adjacent to the reference node. Parents of the reference node are shown in the top row 220 above the reference node. Finally, children of the reference node are shown in the bottom row 240 below the reference node. In this way, user interface 200 displays only relationally proximate nodes to the reference node, in a hierarchical format that makes it easy for a user to understand the relation of a given node to the reference node. By displaying only relationally proximate nodes, the disclosed system and method streamlines displayable node data to user interface 200 and provides a simplified view requiring less screen area than the network data 100 as represented in FIG. 1.

The reference node may be selected and/or the selection of displayed nodes may be adjusted in the user interface 200, for example by: clicking on an appropriate cell; moving a cursor; using scroll arrows 202, 204, 206, 208, 210, 212, 214, and 216; or by swiping left, right, up, or down on the interface 200 with a mouse, finger or stylus. The availability of a reference node selection and/or scrolling options for displaying nodes, may be indicated through a solid scroll arrow or by other indication means. In some embodiments a node cursor may be provided for scrolling the display of nodes in interface 200, with the node cursor constrained to remain in the central column 260 of a certain row in the matrix. For example, moving the node cursor to move left or right may scroll (where permissible) the row where the node cursor is located, with the node cursor remaining in the central column. As another example, when the node cursor is in the top row 220, controlling the node cursor to move up may cause the display to scroll (where permissible), with the node cursor remaining in the top row 220. As another example, when the node cursor is in the bottom row 240, controlling the node cursor to move down may cause the display to scroll (where permissible), with the node cursor remaining in the bottom row 240. A root node (such as node 111) or another default node (such as a node representing the user) may be the initial reference node to provide an initial display of nodes on user interface 200, from which the user may select a subsequent reference node.

When a user selects a reference node, the user interface 200 automatically updates its display of node data by determining downstream and/or upstream branches in the manner described above, and displays certain nodes from the determined branches. Display data is continually and dynamically updated as the user selects or scrolls through different reference nodes on the user interface 200. This will be illustrated through the example figures below.

In FIG. 2, node 111 is the reference node, shown at the center of user interface 200. As described above, node 111 may be set as the initial reference node by default, in order to provide a display of nodes for the user to select a subsequent reference node. Using the methods described above for determining sets of linked nodes from downstream and/or upstream branches, it is determined that node 111 has no parents, no siblings, and only child nodes 121-123. Accordingly, only bottom row 240 is populated with child nodes 121-123, which intuitively informs the user that node 111 has child nodes 121-123. In other embodiments, additional markings (not shown) may be provided to indicate the node relationships to the user.

In FIG. 3, node 122 is now selected as the reference node. For example, node 122 may have been selected by using scroll arrow 216 from FIG. 2, or other means described above. Nodes 121 and 123 are determined as its siblings from the set of linked nodes determined from downstream branches of its parent node (node 111), and displayed in central row 230 adjacent to node 122. Node 111 is determined as its parent node from upstream branches from node 122, and is shown in top row 220 above node 122. Scroll arrow 202 is shown in solid to allow the user to scroll to node 111. Scroll arrow 208 is shown in solid to allow the user to scroll onto node 121. Scroll arrow 210 is also shown in sold to allow the user to scroll onto node 123. Alternatively, the user may simply click onto one of nodes 111, 121, 123 on user interface 200, or move a node cursor onto one of these nodes, in order to select a new reference node.

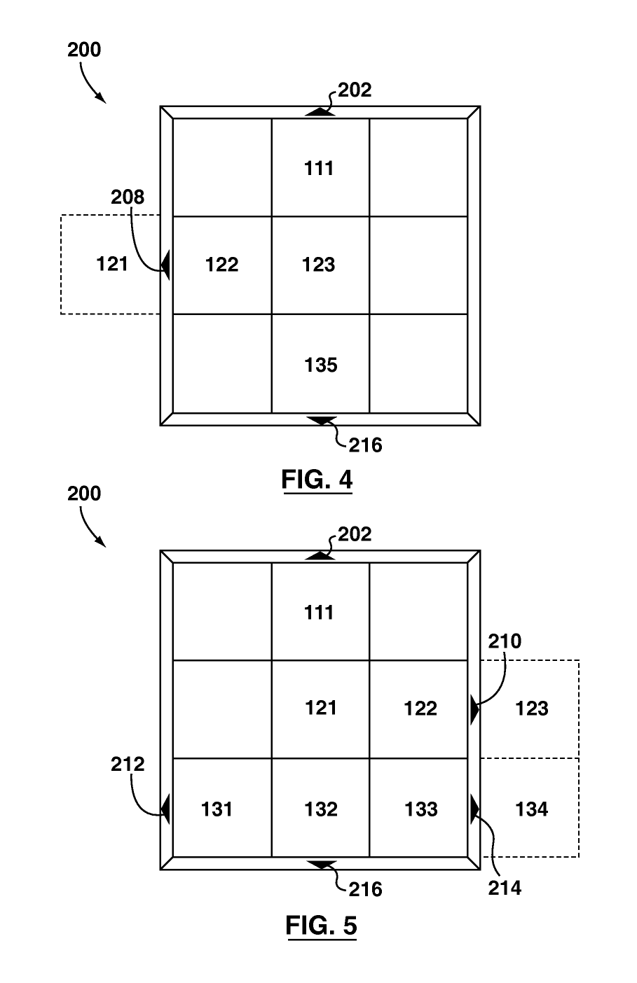

In FIG. 4, node 123 is now selected as the reference node. For example, node 123 may have been selected by using scroll arrow 210 from FIG. 3, or other means described above. Nodes 121 and 122 are identified as its siblings in central row 230. Node 135 is determined as its child node and displayed in bottom row 240. These related nodes are all determined from the set of linked nodes identified from the downstream branches of node 123's parent node (node 111) in the manner described above. Node 111 is identified as the parent node from upstream branches of node 123, and is shown in top row 220. Scroll arrows 202, 208, and 216 are appropriately shown in solid to indicate permissible scrolling options. In this embodiment, sibling node 121 is omitted from the user's display due to the configuration of the user interface 200, but is indicated in outline adjacent to other sibling node 122 for illustration. However, it will be displayed to the user after scrolling left or selecting node 122 as the reference node. In some embodiments (not shown) an indication that further nodes may be scrolled to may be provided, for example by changing the appearance of the associated scroll arrow, or by providing another indicator. For example in FIG. 4 the scroll arrow 208 may be distinguished in appearance to indicated that node 121 may be scrolled into view of the interface 200, while scroll arrows 202 and 216 would not be similarly distinguished in appearance as node 111 has no parent, and node 135 has no child, which may be scrolled into interface 200.

In FIG. 5, node 121 is now selected as the reference node. Sibling nodes 122 and 123, and child nodes 131-134 are determined from downstream branches of parent node 111. Nodes 123 and 134 are omitted from the user's display in this example, but are indicated in outline in rows for sibling and child nodes for illustration. Node 111 is identified as the parent node from upstream branches of node 121. Scroll arrows 202, 210, 212, 214 and 216 are appropriately shown in solid to indicate scrolling options in this example with node 121 as the reference node.

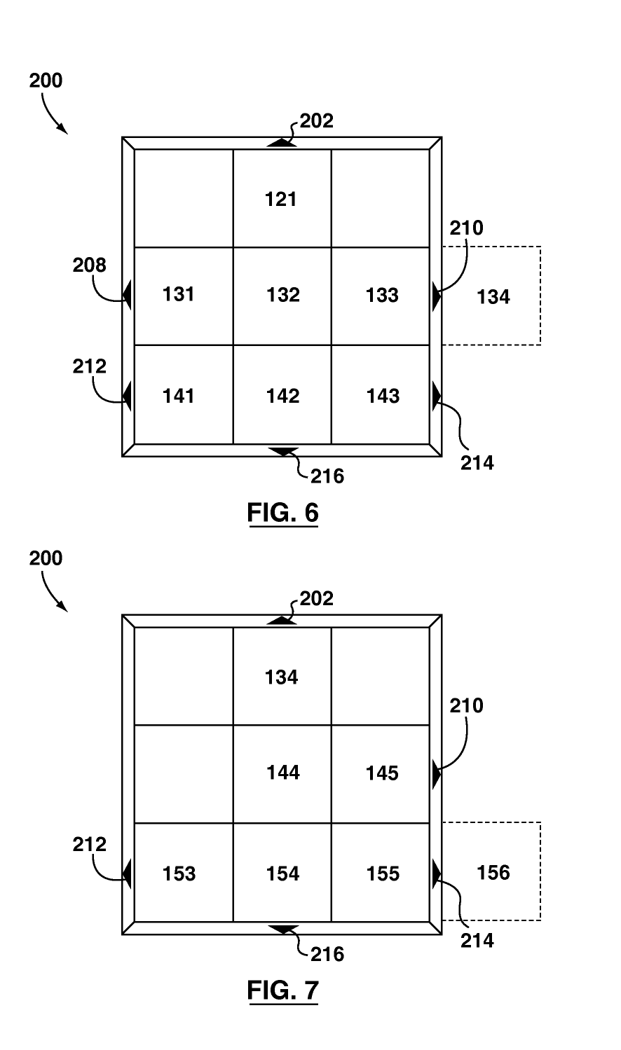

In FIG. 6, node 132 is now selected as the reference node. Sibling nodes 131, 133 and 134 (node 134 omitted from the user's display in this example) and child nodes 141-143 are determined from downstream branches of parent node 121. Various scroll arrows 202-216 are appropriately shown in solid to indicate permissible scrolling options for this example with node 132 as the reference node.

In FIG. 7, node 144 is now selected as the reference node. Sibling node 145 and child nodes 153-156 (node 156 omitted from the user's display in this embodiment) are determined from downstream branches from parent node 134. Various scroll arrows 202-216 are appropriately shown in solid to indicate permissible scrolling options for this example with node 144 as the reference node.

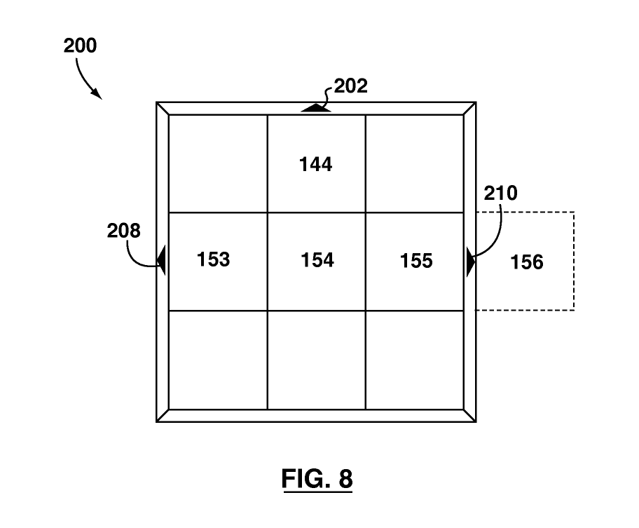

In FIG. 8, node 154 is now selected as the reference node. Sibling nodes 153, 155 and 156 are determined from downstream branches of parent node 144. Various scroll arrows 202-210 are appropriately shown in solid to indicate permissible scrolling options for this example with node 154 as the reference node.

As shown in FIGS. 2-8, the user interface 200 comprises a matrix of a 3×3 array displaying only the reference node's “parent”, “sibling”, and “child” nodes. In other embodiments however, user interface 200 may comprise any number of cells arranged in any type or size of array, including both symmetrical and non-symmetrical arrays. An expanded array for user interface 200 may allow for nodes corresponding to additional relationship types to be displayed. For example, in an embodiment where user interface 200 comprises five (5) separate rows, the top row may be used to display the “grandparent” nodes, the upper row may be used to display the “parent” nodes, the central row may be used to display the “sibling” and reference nodes, the lower row may be used to display the “child” nodes, and the bottom row may be used to display the “grandchild” nodes.

In embodiments where the user interface 200 comprises a symmetric matrix (for example, a 5×5 array), a central row for displaying sibling and reference nodes may traverse the center of the matrix, and a central column for displaying parent and reference nodes may also traverse the center of the matrix. In embodiments where the matrix is non-symmetric (for example a 4×4 array), the central row may comprise a row near the center of the matrix, and central column may comprise a column near the center of the matrix. Therefore, the positional display of reference and parent nodes may vary in different embodiments according the specific layout of the user interface 200.

In some embodiments, multiple nodes may be displayed within a single cell. For example, a cell may be used to display both a node and a bridge node linked to that node. Bridge nodes are explained further below.

### Display of Multi-Parent Network Data

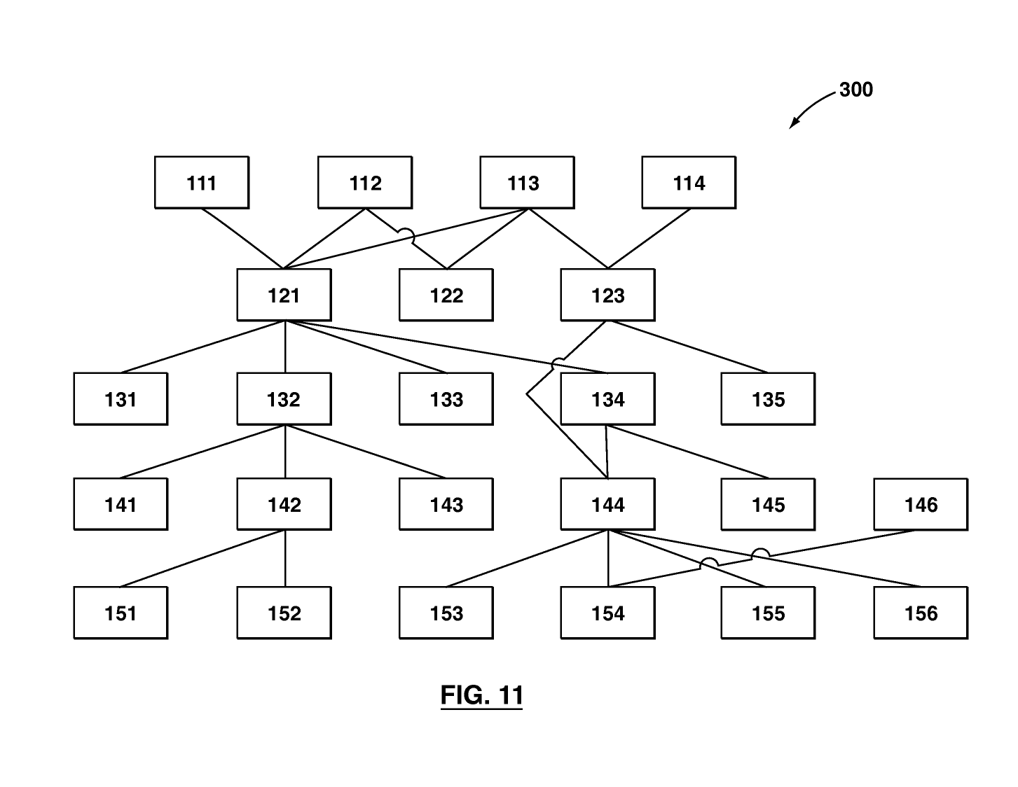

FIG. 11 shows an exemplary set of network data 300 comprising nodes having multiple parents, which may be processed and displayed using the disclosed system and method. The network data 300 in FIG. 11 is similar to network data 100 in FIG. 1, with the exception that it contains additional nodes 112-114 and 146, and that nodes 121-123, 144, and 154 each have more than one parent. As will be illustrated in the examples of FIGS. 12-19 to follow, the disclosed system and method is capable of determining proximately related nodes to a reference node from network data 300, such as its parent, primary sibling, and child nodes, from downstream and upstream branches in relation to the reference node. These nodes may then be displayed to the user to provide relevant relational information in a simplified and intuitive manner.

The user interface 200 in FIGS. 12-19 is substantially similar to that shown in FIGS. 2-8. When displaying tree data comprising multiple-parent nodes however, the cell in top row 220 and central column 260 (directly above display of the reference node) may be used to display a parent reference node. When a user selects a reference node, the disclosed system and method determines if any of the linked nodes are parent nodes of the reference node, and may automatically select an appropriate parent node to be the parent reference node according to one or more selection rules. For example, if the selected reference node has only a single parent node, it may be the parent reference node by default. If a reference node has multiple parent nodes, the system may apply a selection rule to select one of the parent nodes as the parent reference node. In one embodiment, the selection rule will retain a previous parent reference node if it continues to be a viable option (for example, if the user selects another reference node that has the same parent reference node as a parent). A user may also select a parent reference node, for example by scrolling a row containing parent nodes, or by moving a cursor. Primary siblings of the reference node are then determined according to downstream branches from a selected parent reference node. In this way, the user can easily see the reference node's primary siblings based on which of the parents the system or user has selected to be the parent reference node. Secondary siblings of the reference node, which are siblings of the reference node which do not emanate from the parent reference node (i.e. emanate from other parent nodes), may be excluded from display to the user to preserve display area.

In the embodiment of FIG. 12, node 113 is the reference node shown at the central row 230 and central column 260 of user interface 200. Using the same methods described above for determining sets of linked nodes from downstream and/or upstream branches, and as illustrated in FIGS. 2-8, it is determined that node 113 is a root node with no parents, with child nodes 121-123. Accordingly, bottom row 240 is populated with child nodes 121-123, which intuitively informs the user that node 113 has child nodes 121-123.

In FIG. 13, node 122 is now selected as the reference node. Node 122 may have been selected by using scroll arrow 216 from FIG. 12, or by other means described above. Nodes 112 and 113 are determined as its parent nodes from upstream branches from node 122, and are shown in top row 220. Node 113 is shown as the parent reference node (either by automatic selection or user selection), and nodes 121 and 123 are determined as the reference node's primary siblings from the downstream branches emanating from the parent reference node (node 113) and are displayed in central row 230 adjacent to node 122. Scroll arrow 202 is shown in solid to allow the user to select node 113 as the reference node. Scroll arrow 204 is also shown to allow the user to scroll top row 220 and select node 112 as the parent reference node. Scroll arrow 208 is shown in solid to allow the user to scroll center row 230 and select node 121 as the reference node. Scroll arrow 210 is also shown in solid to allow the user to scroll center row 230 and select node 123 as the reference node.

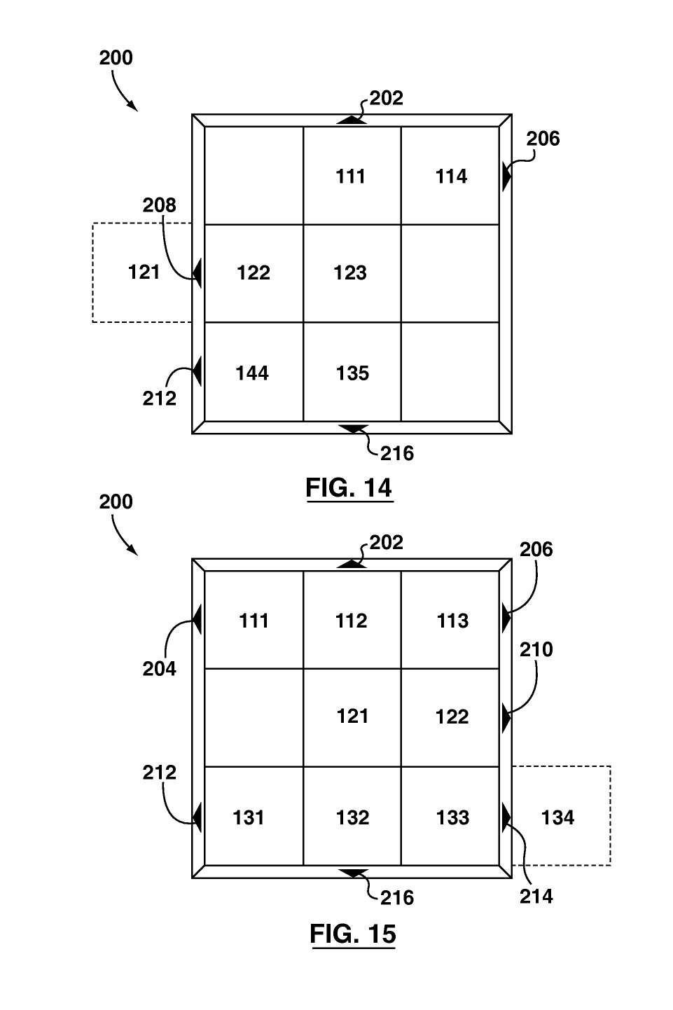

In FIG. 14, node 123 is now selected as the reference node. Node 123 may have been selected by using scroll arrow 210 from FIG. 13, or by other means described above. Nodes 113 and 114 are determined as its parent nodes from upstream branches of node 123, from which node 113 is selected as the parent reference node (as shown in central column 260 of top row 220). Nodes 121 and 122 are determined to be primary siblings of the reference node, and nodes 135 and 144 are determined as its child nodes; these nodes may be determined from downstream branches emanating from the parent reference node (node 113). Scroll arrows 202, 206, 208, 212, and 216 are appropriately shown in solid to indicate permissible scrolling options, which in some cases will also result in the selection of a new reference node and/or parent reference node. In this embodiment, primary sibling node 121 is omitted from the user's display due to the configuration of the user interface 200. However, it may be displayed if the user scrolls the center row 230 using scroll arrow 208 or directly clicks on node 122 to select it as the reference node.

In FIG. 15, node 121 is now selected as the reference node. Nodes 111-113 are determined as the parent nodes from upstream branches of node 121, of which node 112 is selected to be the parent reference node. Primary sibling node 122 and child nodes 131-134 are determined from downstream branches of the parent reference node (node 112). Secondary sibling node 123 emanating from other parent node 113, is not displayed to the user. Scroll arrows 202, 204, 206, 210, 212, 214 and 216 are appropriately shown in solid to indicate scrolling options in this example with node 121 as the reference node.

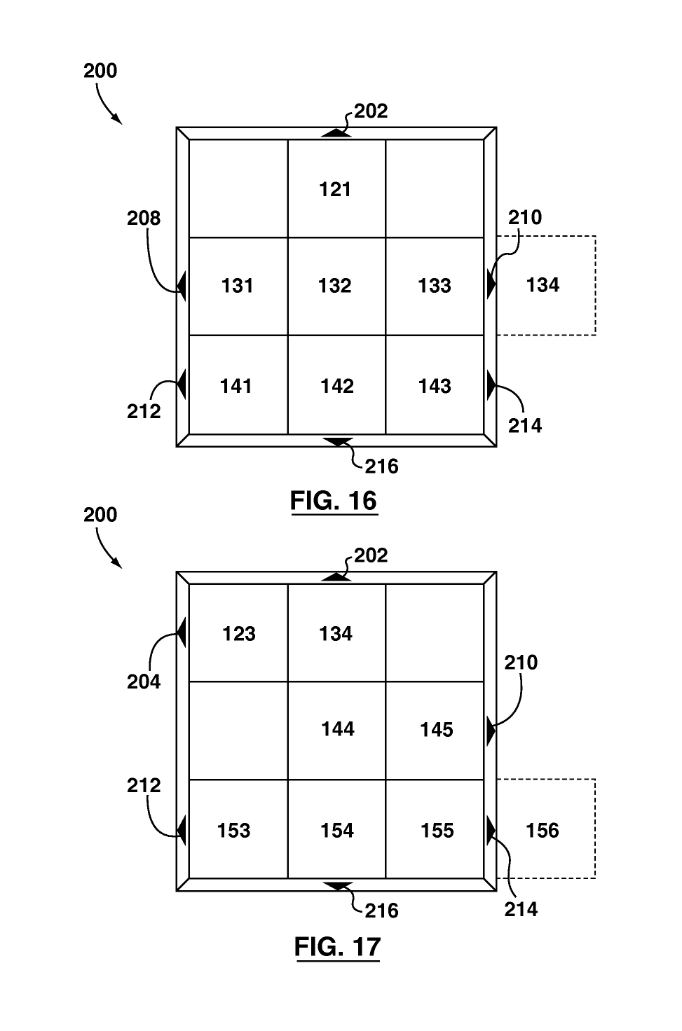

In FIG. 16, node 132 is now selected as the reference node. Node 121 is its only parent node. Primary sibling nodes 131, 133 and 134 (node 134 omitted from the user's display in this example) and child nodes 141-143 are determined through downstream branches of parent reference node 121. Cousin node 135, obtained from the third set of linked nodes, is not shown to the user. Various scroll arrows 202-216 are appropriately shown in solid to indicate permissible scrolling options in this example with node 132 as the reference node.

In FIG. 17, node 144 is now selected as the reference node. Nodes 123 and 134 are determined as the parent nodes from upstream branches of node 144, of which node 134 is selected as the parent reference node. Primary sibling node 145 and child nodes 153-156 (node 156 omitted from the user interface 200 in this example) are determined through downstream branches from parent reference node 134. Secondary sibling node 135 emanating from other parent node 123 is not shown to the user. Various scroll arrows 202-216 are appropriately shown in solid to indicate permissible scrolling options in this example with node 144 as the reference node.

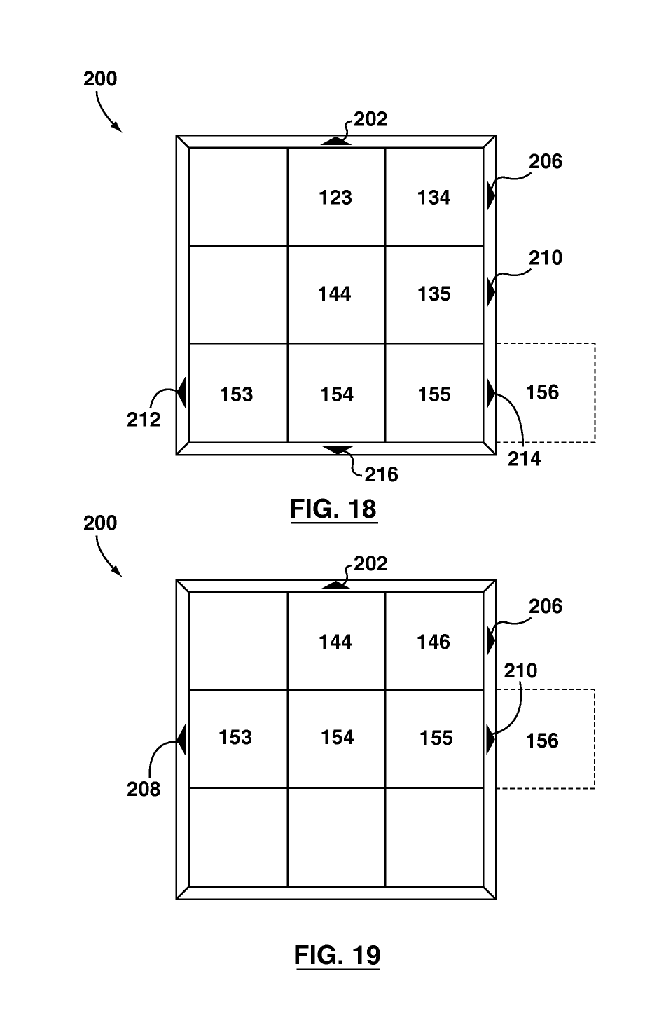

In FIG. 18, node 144 still remains as the reference node. However, node 123 has alternatively been selected as the parent reference node instead of node 134 in FIG. 17. Accordingly, node 135 is determined as the primary sibling node from downstream branches from the parent reference node (node 123), along with child nodes 153-156 (node 156 omitted from the user's display in this example). Child nodes 153-156 may alternatively be determined through downstream branches from parent node 144. Since a different parent reference node was chosen in this example, the primary siblings displayed in the central row 230 have changed according to the parent reference node, and node 145 is no longer shown in the central row 230. Scroll arrow 206 is shown in solid to indicate the possible selection of node 134 as the parent reference node, and scroll arrows 202 and 210-216 are appropriately shown in solid to indicate additional permissible scrolling options for this example with node 144 as the reference node.

In FIG. 19, node 154 is now selected as the reference node. Parent nodes 144 and 146 are determined from upstream branches from node 154, and node 144 is selected as the parent reference node. Primary sibling nodes 153, 155 and 156 are determined through downstream branches of parent reference node 144 (node 156 omitted from the user's display in this example). Various scroll arrows 202-210 are appropriately shown in solid to indicate permissible scrolling options for this example with node 154 as the reference node.

Accordingly, for network data comprising nodes having multiple parents, the user interface 200 facilitates display and selection of parent reference nodes, and displays the siblings of a reference node according to parent reference node. This feature provides for an organized, efficient, and interactive display of network data to help reduce screen size requirements.

### Display of Chain Data

The disclosed system and method may also be applied to process and display network data comprising chain data, including chain mail, chain messages or other types of communications that are distributed on a large scale. A chain message, for example, may comprise a help message, an advertisement, or a prayer request. The chain message may, for example, be distributed over a social network, and propagate between different users of the social network, who may connect to the social network on individual user terminals. Accordingly, the disclosed system and method may organize and streamline the display of a chain message that has propagated between different users of a social network.

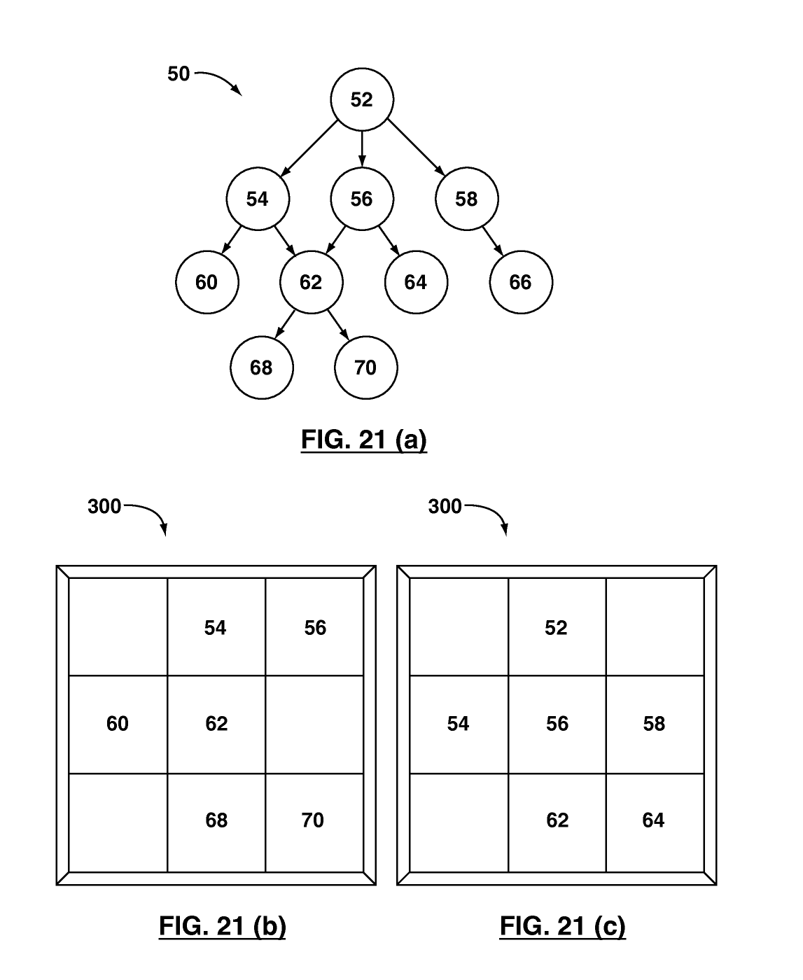

FIG. 21(a) is an exemplary set of network data 50 representing the distribution of a chain message between users of a social network, such as network 1000 described in FIG. 10. The nodes 52-70 of network data 50 each represent different users of the social network who have sent and/or received the chain message, and links between the nodes 52-70 represent a sender-recipient relationship between respective nodes. For example, node 52 is the root node being the topmost node, and is the originator of the chain message. Node 54 is a “sender” of the message to node 60, and node 60 is the “recipient” of the message from node 54. Further, nodes 54 and 56 are both “senders” of the message to node 62. In the same way as described above for FIGS. 1 and 11, nodes 52-70 are arranged in a tree structure through multiple sender-recipient relationships between various pairs of nodes. Accordingly a “sender” may be analogized as a “parent”, and a “recipient” may be analogized as a “child”, following the methods and examples described above.

A user of the social network, operating on a user terminal such as client computer system 1002 or 1004 in FIG. 10, may wish to see the propagation of the chain message over the social network. The disclosed system and method may accordingly determine proximately related nodes to a reference node, as selected by the user, and display those nodes to the user through a user interface (such as user interface 200 in FIGS. 2-8 and 12-19). Analogous to the “parent reference node” described above, the user may in the case of chain messages, further select a “parent sender node”, from which the reference node's “co-recipients” (e.g. “siblings”) may be determined for a given “parent sender node”.

FIGS. 21(b)-(c) are exemplary embodiments of a user interface 300, which may be used to display the network data 50 of FIG. 21(a) that represents the propagation of a chain message over a social network. Analogous to the user interface 200 in FIGS. 2-8 and 12-19, user interface 300 comprises a 3×3 array formed from intersecting three rows (top row, middle row, and bottom row) and three columns (left column, center column, and right column). Each cell of the interface 300 may be used to display a node 52-70 from network data 50. The center cell (middle row, center column) may be used to display a reference node. The node above the reference node (top row, center column) may be used to display a parent sender node (when appropriate). The display of proximately related nodes to a reference node may be performed in the same manner using the same methods described above for network data 50, as will be illustrated below.

In FIG. 21(b), node 62 is selected as the reference node and displayed in the center of user interface 300. Nodes 54 and 56 are shown in the top row as the “sender” nodes to reference node 62, as determined from upstream branches from node 62. Node 54 is shown as the parent sender node (selected automatically or by user selection) being at the center column of the top row. Node 60 is shown in the middle row as a “primary co-recipient” of the message from parent sender node 54 (as determined from downstream branches of parent sender node 54). Nodes 68 and 70 are shown in the bottom row as “recipients” of the message from reference node 62, as determined from downstream branches emanating from reference node 62 (or perhaps nodes 54 or 56 in certain embodiments). Node 64, which is a “secondary co-recipient” from other sender node 56, is excluded from the display. Accordingly, the user interface 300 appropriately displays related nodes to a reference node, in a manner that intuitively describes the hierarchical propagation of the chain message (through users represented as nodes) in the social network. For example, the user will understand the top row of user interface 300 to represent “sender” nodes to the reference node, the bottom row to represent “recipient” nodes of the reference node, and the middle row to represent “co-recipient” nodes according to a specific parent sender node.

As a further example, in FIG. 21(c), node 56 is selected as the reference node and displayed in the center of user interface 300. Node 52 is shown in the top row as a “sender” node to reference node 56, as determined from upstream branches from node 56. Nodes 54 and 58 are shown in the middle row as a “primary co-recipients” of the message from the same sender node 52 (as determined from downstream branches of sender node 52). Nodes 62 and 64 are shown in the bottom row as “recipients” of the message from reference node 56, as determined from downstream branches emanating from reference node 56 (or perhaps node 52 in other embodiments).

Network Data with Bridge Connections

In certain embodiments, the network data may comprise bridge nodes that are connected to other network nodes by a bridge connection. Referring to FIG. 1 for example, a bridge connection is shown as a horizontal line connecting node 111 to bridge node 99. A bridge connection may represent a peer type relationship. For example, when the network data comprises family tree data, the bridge connection may represent a spousal relationship. Alternatively, the bridge connection may be a link to a different set of network data to be displayed through the user interface 200.

Bridge connection indicators may be displayed in user interface 200 to indicate a bridge connection from the reference node (or another node) to a bridge node. The bridge connection indicator may also provide further information related to their respective bridge connections and/or bridge nodes. For example, “mousing over” or clicking on a bridge connection indicator may cause bridge node information or bridge connection information to be displayed to the user.

When the reference node has one or more bridge connections, a bridge node connected to the reference node may be displayed in a node cell. In some embodiments the node cell may by separate from the user interface 200, although it may be proximate to the user interface 200. In other embodiments the node cell may be shown within the user interface 200, for example, in the central row next to the reference node (where a sibling node might otherwise be displayed). In some embodiments a bridge node may be displayed in a split-cell format in the same cell as the reference node.

A user may select a bridge node, for example, by clicking on the bridge node (such as bridge node 99 in FIG. 1) using the various selection methods described above. When a bridge node is selected, it becomes the reference node from which downstream and upstream branches may be determined. When displayed in user interface 200, a bridge node may be indicated with a distinguishing color, border, or format to distinguish it from other nodes (for example, to distinguish it from a sibling node).

### Infrastructure

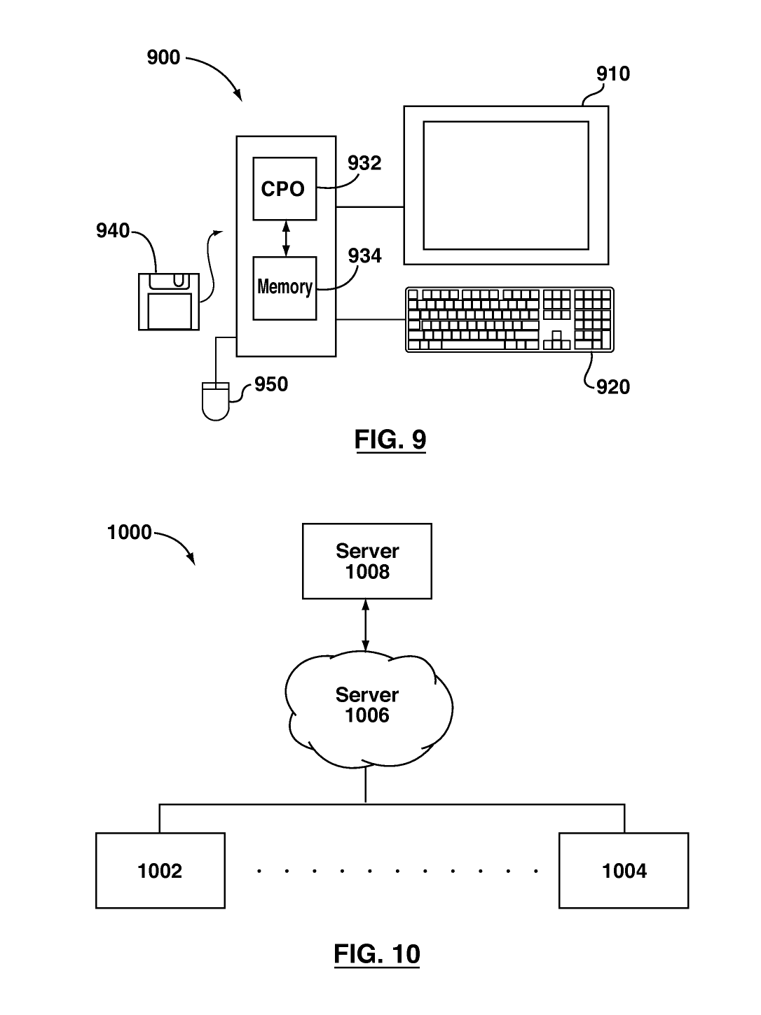

FIG. 9 shows a computer system 900 in which the disclosed system and method may be implemented. Computer system 900 comprises processing means such as processor 932 linked to a non-transitory computer readable medium such as a memory 934. For example, processer 932 may comprise a microprocessor, a microcontroller, a Field Programmable Gate Array (FPGA), or an Application-Specific Integrated Circuit (ASIC). The processor 932 is operable to perform the various features described above, including the determination of linked nodes comprising various upstream and downstream branches emanating from reference node or parent reference node. Memory 934 may comprise a random access memory (RAM) or other dynamic storage device for storing information, statements, and instructions to be executed by processor 932 for performing the various methods described above. Memory 934 may also be used for storing temporary variables or other intermediate information during execution of instructions by processor 932. Computer system 900 may further comprise a read only memory and/or other static storage device (not shown) coupled to the processor 932 for storing stating information that is readable and executable by the processor 932. Computer system 900 may be in the form of any personal computing device, such as a desktop or laptop computer, smart phone, mobile computing device such as a tablet, digital personal assistant, or communication device, and may also form the client 1002, 1004 or server 1008 computer system in FIG. 10 described below.

An optional data storage device 940 such as a magnetic disk, optical disk, solid-state drive, or corresponding drive may also be coupled to the computer system 900 for storing information and instructions to be executed by the processor 932. Computer system 900 further comprises a display device 910, such as a cathode ray tube (CRT) or a liquid crystal display (LCD) for displaying information processed by processor 932 to a computer user. For example, image, textual, video, or graphical depictions of information may be presented to the user on display device 910. For example, nodes determined by processor 932 from various upstream and downstream branches emanating from a reference or parent reference node, may be displayed to the user through display device 910. A user input device 920, such as a keyboard including alphanumeric and other keys may be coupled to processor 932 for communicating information and/or command selections. A cursor control device 950, such as a conventional mouse, trackball, track pad, touch screen, or other type of cursor direction keys, may be coupled to processor 932 for communicating direction information and command selection and for controlling cursor movement on display 910. For example, a user may use the user input device 920 or control device 950 to input selection of a reference node or parent reference node for processor 932 to determine corresponding upstream and downstream branches.

FIG. 10 illustrates a network environment 1000 in which embodiments of the present disclosure may operate. In the network environment 1000 of FIG. 10, a server computer system 1008 that comprises the processor 932 and memory 934 shown in FIG. 9 is coupled to a wide-area network 1006. Wide-area network 1006 includes the Internet, or other proprietary network. Wide-area network 1006 may include conventional network backbones, long-haul telephone lines, Internet service providers, various levels of network routers, and other conventional means for routing data between computers. Using conventional network protocols, server 1008 may communicate to a plurality of client computer systems 1002, 1004 through wide-area network 1006 in various ways. Various users may interact with the client computer systems 1002, 1004 to interact, manipulate, and be displayed the tree data as depicted in FIGS. 2 to 8 and 12 to 19. For example, a user may select or provide a user input for selecting a reference node or a parent reference node through client computer systems 1002, 1004. Further, nodes comprising upstream and downstream branches from selected nodes may also be displayed to the user through display devices of client computer systems 1002, 1004. The client computer systems 1002, 1004 may also be connected directly to wide-area network 1006 through an internet connection or other network transmission line. In another alternative network topology, wide-area network 1006 is connected to a gateway computer (not shown). Gateway computer may be used to route data to additional clients (not shown) through a local area network (LAN) 116. In this manner, various clients can communicate with each other through server 1008 and wide-area network 1006 and through gateway computer and local area network.

Still referring to FIG. 10, server 1008 can communicate with client computer systems 1002, 1004 using any of a variety of network connection means. In a particular embodiment, server 1008 may operate as a web server when World-Wide Web (WWW) is used as the wide area network 1006. Using HTTP protocol and the HTML coding language across the wide-area network 1006, the server 1008 may communicate across the World-Wide Web with clients 1002, 1004. Client computer systems 1002, 1004 may use a client application program such as a web browser, web application software, or HTML renderer for accessing image, graphical, and textual data provided by the server 1008. Client computer systems 1002, 1004 may also supply information to the server 1008 through the wide-area network 1006 and the server 1008 may return processed data to clients 1002, 1004 for display.

While the server 1008 is shown in FIG. 10 as a separate device from client computer systems 1002, 1004, in other embodiments the server 1008, or functions of the server 108, may be implemented or performed by one of the client computer systems 1002, 1004, or a combination of both client computer systems 1002, 1004.

It is contemplated that any part of any aspect or embodiment discussed in this specification can be implemented or combined with any part of any other aspect or embodiment discussed in this specification.

For the sake of convenience, the exemplary embodiments above are described as various interconnected functional blocks. This is not necessary, however, and there may be cases where these functional blocks are equivalently aggregated into a single logic device, program or operation with unclear boundaries. In any event, the functional blocks can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible. The scope of the claims should not be limited by the preferred embodiments set forth in the examples, but should be given the broadest interpretation consistent with the description as a whole.

1. A computer-implemented method for displaying network data having a plurality of linked nodes, the method comprising:
(a) determining which of the linked nodes is a reference node based on a first user input;
(b) determining whether the reference node has at least one parent node, and if the reference node has at least one parent node:
(i) determining a parent reference node; and
(ii) determining a set of linked nodes from downstream branches that emanate from the parent reference node;
otherwise:
(iii) determining a set of linked nodes from downstream branches that emanate from the reference node; and
(c) displaying at least one of the linked nodes from the set of linked nodes to the user.

2. The method of claim 1 wherein the parent reference node is selected from the at least one parent node.

3. The method of claim 1 wherein the set of linked nodes comprises all of the linked nodes that emanate from downstream branches from the parent reference node or the reference node.

4. The method of claim 1 wherein when the reference node has one parent node, the one parent node is the parent reference node.

5. The method of claim 1 wherein when the reference node has a plurality of parent nodes, the parent reference node is a previously selected parent reference node.

6. The method of claim 1 wherein when the reference node has a plurality of parent nodes, the parent reference node is a previously selected reference node.

7. The method of claim 1 further comprising:
(a) determining a second set of linked nodes from upstream branches that emanate from the reference node; and
(b) displaying at least one of the linked nodes from the second set of linked nodes to the user.

8. The method of claim 1, wherein when the reference node has at least one parent node, the method further comprises:
(a) determining primary sibling nodes as sibling nodes of the reference node which emanate from the parent reference node; and
(b) displaying at least one of the primary sibling nodes to the user.

9. The method of claim 1, wherein when the reference node has a plurality of parent nodes, the method further comprises:
(a) determining secondary sibling nodes as sibling nodes of the reference node which do not emanate from the parent reference node; and
(b) excluding at least one of the secondary sibling nodes from being displayed to the user.

10. The method of claim 1 wherein the nodes are displayed in a matrix comprising a plurality of rows and columns, wherein the plurality of rows comprises upper, central, and lower rows, and the plurality of columns comprises a central column.

11. The method of claim 10 wherein the reference node is displayed in the central row of the matrix.

12. The method of claim 10 wherein the reference node is displayed in the central column of the matrix.

13. The method of claim 10 wherein when the reference node has at least one parent node, displaying the nodes further comprises displaying the parent reference node in the central column of the matrix.

14. The method of claim 10 wherein when the reference node has at least one parent node, displaying the nodes further comprises displaying the parent reference node in the upper row of the matrix.

15. The method of claim 10 wherein when the reference node has at least one child node, displaying the nodes further comprises displaying the at least one child node in the lower row of the matrix.

16. The method of claim 10 wherein when the reference node has at least one parent node, and wherein displaying the nodes further comprises displaying sibling nodes from the parent reference node in the central row of the matrix.

17. The method of claim 1 wherein the network data comprises any one of tree data, genealogy data, transmission history data, corporate structure data, multi-level marketing data, chain data, and social connection data.

18. The method of claim 1 wherein when the reference node has at least one grandparent node, the method further comprises:
(a) determining a reference grandparent node from the at least one grandparent node;
(b) determining a primary branch as a downstream branch emanating from the reference grandparent node which includes the parent reference node;
(c) determining a third set of linked nodes from downstream branches that emanate from the reference grandparent node which excludes the nodes of the primary branch; and
(d) excluding at least one of the linked nodes from the third set of linked nodes from being displayed to the user.

19. The method of claim 1 further comprising:
(a) determining whether a bridge node is directly linked to the reference node; and
(b) displaying the directly linked bridge node to the user.

20. The method of claim 19 wherein the bridge node is displayed in the central row of the matrix.

21. The method of claim 19 wherein the bridge node is displayed adjacent to the reference node in the matrix.

22. The method of claim 19 wherein the bridge node is displayed in a location outside of the matrix.

23. A system for displaying network data having a plurality of nodes, the system comprising:
(a) a processor;
(b) a display communicatively linked to the processor; and
(c) a memory communicatively linked to the processor, the memory having encoded thereon statements and instructions to configure the system to carry out the method as claimed in claim 1.

24. A non-transitory computer readable medium having encoded thereon statements and instructions to configure a computer implemented system to carry out the method as claimed in claim 1.
